(19) United States
(12) Patent Application Publication
(10) Pub. No.: US 2007/0149404 A1
(43) Pub. Date: Jun. 28, 2007

(54) Microbicidal compositions

(75) Inventors: Jürgen Huff, LUDWIGSHAFEN (DE); Juan Diego Lopez Casanello, Speyer (DE); Shoaib Qureshi, Nottinghamshire (GB); John-Bryan Speakman, Bobenheim (DE); Mark Trewhitt, Wachenheim (DE); Sergi Vizoso-Sansano, Barcelona (ES); Dieter Zeller, Speyer (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, LUDWIGSHAFEN (DE)

(21) Appl. No.: 10/583,225

(22) PCT Filed: Dec. 22, 2004
(86) PCT No.: PCT/EP04/14586

§ 371 Date: Jun. 16, 2006

(30) Foreign Application Priority Data
Dec. 24, 2003 (GB) 0330023.3

(51) Int. Cl. A01N 43/64; A01N 37/34; A01N 47/40; A01N 37/00

(52) U.S. Cl. 504/141; 514/231.2; 514/383; 514/522; 504/142

(57) ABSTRACT

Microbicidal compositions for the protection of industrial products and use in industrial or technical systems, comprising at least two different biocides selected from the group of active substances known as fungicides, insecticides, acaricides, or herbicides in the field of crop protection. Industrial materials comprising said mixture of biocides.

This invention relates to microbicidal compositions for the protection of industrial products and use in industrial or technical systems, comprising least two different biocides selected from the group of active substances known as fungicides, insecticides, acaricides, nematicides or herbicides in the field of crop protection. The invention furthermore relates to industrial materials comprising said mixture of biocides.

The term “microbicide” or more simply “biocide” is used in general to describe all agents that kill microbial life. In a more specific meaning the term is used for compounds or compositions used to prevent microbial growth in industrial products and in industrial or technical systems, for example paints, coatings, plastics, water cooling systems, paper manufacturing, wood protection, cosmetics, washing and cleaning materials, sealing compounds, window cement, or hydraulic fluids. Microbicidal compositions for combating microorganisms in industrial products are known in the art. Details are disclosed for instance in “Microbicides” Ullmann's Encyclopedia of Industrial Chemistry, 6^{th} Edition, 2000 Electronic Release.

It has been suggested to use specific compounds which are known as active substances in the field of crop protection, such as agricultural fungicides, insecticides, nematicides or herbicides, also as biocides for industrial products and processes.

As an example, the fungicide 1-dodecylguanidinium hydrochloride or—acetate, also known as “dodine”, may be mentioned which has been suggested for use in polymer emulsions (EP-A 1 188 377) or inhibition in industrial fluids (WO 01/11954) and many other applications.

Similarly, the herbicide 2,4-dichlorophenoxyacetic acid has been suggested as biocide for the production of paper (SU 1542912), as additive for bitumen (DD 98102), or in anti-fouling coating compositions (EP-A 286 243).

The fungicide cis-4-[3-[4-(1,1-dimethylethyl)phenyl]-2-methylpropyl]-2,6-dimethylmorpholine (fenpropimorph) has been suggested by EP-A 370 371 as wood preservative.

WO 96/36739 discloses the fungicides (1RS, 5RS; 1RS, 5SR)-5-(4-chlorobenzyl)-2,2-dimethyl-1-(1H-1,2,4-triazol-1-ylmethyl)cyclopentanol (Metconazole) or cis-3-(2-Chlorphenyl)-2-(4-fluorphenyl)-2-(triazol-1-ylmethyl)-oxiran (Epoxiconazole) in combination with at least one phenolic compound as biocide for the protection of leather.

However, besides the microbicidal efficiency, biocides for technical systems have to fulfill many additional requirements, which are in no way important for their use in the field of plant protection. For example, there can be mentioned long term stability, stability at high temperatures or increased pressures, or stability at very high or very low pH-values, compatibility with industrial and consumer product matrices such as cosmetics products, metal working fluids and paint formulations. Furthermore, exhibit a broad spectrum efficacy against bacteria, viruses, algae, fungi, and yeasts is desirable. Many active substances known in the field of plant protection do not yield satisfactory results as biocides in industrial materials and processes.

An important field of use for biocides is the so called in-can-preservation, e.g. the preservation of paints, lacquers, polymer emulsions, adhesives, PUR systems and the like packed into cans or similar containers. In such systems, the biocide has a double function. At first, it is the aim to protect the (aqueous based) material as long as it is in the can. Secondly, it is also the aim to protect the dry film obtained by the use of, for example, the paint or the lacquer. For that purpose, it is important that the biocide retains its activity also in the dry film and furthermore that it remains long-term in the film and does not become leached out too fast when the film is in contact with water.

The above mentioned dodine shows a broad-spectrum activity which is sufficient for many cases however its water solubility is relatively high for long-term stability and therefore, films containing dodine tend to become leached out too fast when in contact with water.

Therefore, the problem to be solved by the invention was to provide microbicidal compositions especially suitable for in-can-preservation and film preservation of paints, lacquers and the like on basis of active substances known in the field of plant protection, such as agricultural fungicides, insecticides, acaricides, nematicides, or herbicides.

Thus, according to one aspect, the invention provides the use of a microbicidal composition comprising at least two different biocides, wherein said biocides are selected from the group of active substances known as fungicides, insecticides, acaricides, nematicides, or herbicides in the field of crop protection each comprising at least one structural element selected from the group of 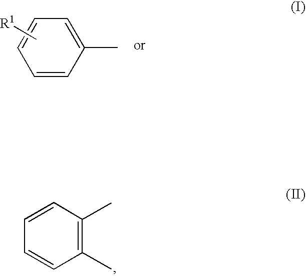
whereby R¹ is selected from the group of F, Cl, and C₁—C₄-alkyl for killing fungi, yeasts, algae and bacteria, in industrial materials and/or industrial processes, and wherein at least one of the biocides comprising groups (I) and/or (II) is of hydrophobic character.

In a preferred embodiment of the invention, the composition is in particular used for in-can-preservation of coating compositions and coatings obtained by the use of such compositions.

In a second aspect, the invention provides an industrial material comprising said composition of at least two of said biocides.

Regarding the invention, the following may be stated specifically:

The abbreviations used in the present application for the active substances are the ISO approved names according to ISO 1750 “Pesticides and other agrochemicals—Common names”.

The invention relates to the use of certain biocidal actives in technical applications or technical products. Therapeutic or medical applications in or on the human or animal body, and applications in crop protection, are not embraced by the present invention.

“Industrial materials” are to be understood as non-living materials, as they are attacked by microbes in technical-industrial processes. Industrial materials which can be protected from microbial damage or destruction by formulations embodying the invention are, for example, finishings, drilling oils, dispersions, emulsions, dyes, adhesives, lime, lacquers, pigment preparations, paper, paper processing materials, textiles, textile processing materials, leather, leather processing materials, wood, coating materials, anti-fouling coatings and colours, plastics articles, plastics substrates such as polyethylene, polypropylene, polyamide, polyurethane and the like, cosmetics, washing and cleaning materials, cooling lubricants, hydraulic fluids, joint sealing compounds, window cement, thickening solutions; fleeces as well as carpet layers and other materials which can be attacked or destroyed by microorganisms.

“Industrial processes” are to be understood as installations, especially chemical installations, manufacturing installations or machinery, in which “industrial materials” are used as auxiliaries or reaction media. Examples include reaction vessels, storage vessels, heating vessels (radiators), heat exchanger circuits or air conditioning units.

The term “coating compositions” is well known to the skilled artisan and comprises all kinds of industrial materials which can be used for coating other materials whereby the technique used for coating is not relevant. Typical coating compositions usually comprise a binder system, a solvent or a solvent composition and further additives. As examples there may be mentioned paints, dispersions, or lacquers for coating.

According to the invention, the microbicidal composition used comprises at least two different biocides, selected from the group of active substances known as fungicides, insecticides, acaricides, nematicides, or herbicides in the field of crop protection.

In a preferred embodiment of the invention the biocides used are selected from different members of said group, i.e. one selected from the group of herbicides and one selected from the group of fungicides. In a more preferred embodiment, the composition comprises at least one fungicide in combination with at least one compound selected from the group of insecticides, acaricides, nematicides, or herbicides.

At least one of the biocides used should be of hydrophobic character. The term “hydrophobic character” shall mean that in general, that the solubility in water at room temperature should not exceed about 500 ppm (mg/kg), preferably 200 ppm, more preferably 100 ppm, even more preferably 50 ppm, and most preferably 10 ppm.

Also the other biocide(s) used should have at least a limited solubility in water at room temperature. The term “limited solubility” shall mean that in general, the solubility in water at room temperature should not exceed about 1000 ppm, preferably 750 ppm, and most preferably 650 ppm.

Preferably, all biocides used should be of hydrophobic character.

At least two biocides used each comprise at least one structural element of the general formulas (I) or (II).

The structural element according to formula (I) is a substituted aromatic ring 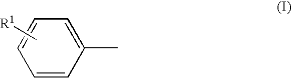
wherein R¹ is selected from the group of F, Cl, and C₁—C₄-alkyl, in particular methyl, ethyl, n-propyl, i-propyl, n-butyl, i-butyl, and t-butyl.

Optionally the aromatic ring may be substituted by one or more additional substituents R² selected independently from the group of F, Cl, C₁—C₄-alkyl, —O—CH₃, —COOH, or —COOR³, wherein R³ is a C₁—C₈-alkyl group, preferably a C₁—C₄-alkyl group. COOH-groups should only be present as long as the hydrophobic character or the limited solubility of the biocide in water is not affected by the existence of the COOH-group. In general not more than one —COOH group should be present in the biocides used for the present invention. Preferably, no —COOH group should be present.

The aromatic group (I) is connected to the rest of the molecule of the active substance. As connecting groups ether groups —O—, hydrocarbon groups, such as —CH₂—, N-acyl-groups —N—CO— or carbonyl groups —CO— may be used. The group (I) may also be connected directly to heterocyclic groups or other groups.

Formula of active compounds are known to the skilled artisan and are collected in data bases such as “Compendium of Pesticide Common Names” or “The Pesticide Manual—A World Compendium” which is also available via internet, e.g. http://www.hclrss.demon.co.uk/.

Examples of suitable active substances comprising the aromatic group (I) as unit comprise:

| | | |
|---|---|---|
| Fenpropimorph | 4-[2-Methyl-3-(p-tert.butyl- phenyl)-propyl]-2,6-cis- dimethylmorpholin CAS: 67306-03-0 | 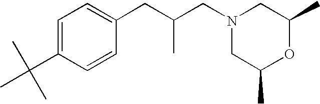 |
| Chlorfenapyr | 4-Brom-2-(p-chlorphenyl)- 1-(ethoxymethyl)-5-(tri- fluormethyl)-pyrrole-3- carbonitril CAS: 122453-73-0 | 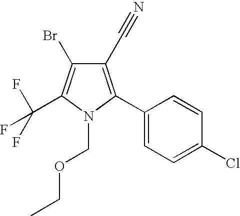 |
| Picolinafen | 6-(3-Trifluormethyl-phen- oxy)-pyridine-2-(N-3-fluor- phenyl)-carboxylic acid amide CAS: 137641-05-5 | 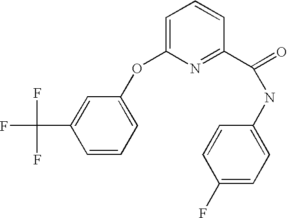 |
| Dichlorprop | 2,4-Dichlorophenoxy- propionic acid CAS: 120-36-5 | 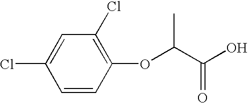 |
| 2,4-D | 2,4-Dichlorphenoxy acetic acid CAS: 94-75-7 | 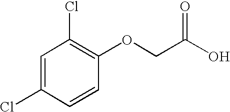 |
| Metconazole | (1RS, 5RS;1RS, 5SR)-5- (4-chlorobenzyl)-2,2-di- methyl-1-(1H-1,2,4-tri- azol-1-ylmethyl)cyclo- pentanol CAS: 125116-23-6 | 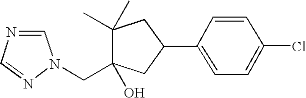 |
| Epoxiconazole | cis-3-(2-Chlorphenyl)-2- (4-fluorphenyl)-2-(triazol- 1-ylmethyl)-oxiran CAS: 125319-73-2 | 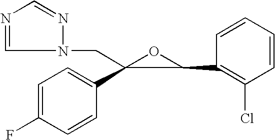 |

The structural element according to formula (II) is a divalent aromatic group which is 1,2 connected to the rest of the molecule.

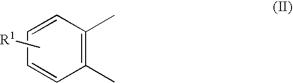

The group may act as bridging group, however, in general (II) is part of a molecule comprising condensed rings, i.e. the two substituents R⁴ and R⁵ are linked together to form a closed ring which itself may be connected with further rings and/or substituents.

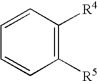

The group (II) may be further substituted in 3 to 6 position by one or more substituents R¹ and/or R² as defined above.

An example of a suitable active substance comprising the divalent aromatic group (II) as unit is:

| | | |
|---|---|---|
| Dithianon | 2,3-Dicyano-1,4-dithia- anthraquinone CAS: 3347-22-6 | 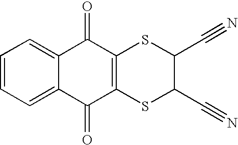 |

Solubilities in water at room temperature are summarized in the following table:

| Common name | Aq. Solubility (ppm) |
|---|---|
| Dichlorprop | 620 |
| Dodine | 630 |
| 2,4-D | 600 |
| Bentazone | 570 |
| Fenpropimorph | 4.3 |
| Epoxiconazole | 66.3 |
| Dithianon | 1.4 |
| Metiram | 2.7 |
| Metconazole | 15 |
| Chlorfenapyr | 0.15 |
| Picolinafen | 0.004 |

Preferred active substances comprising the aromatic group (I) as unit comprise fenpropimorph, chlorfenapyr, metconazole, epoxiconazole, 2-4-D, Dichlorprop P, and dithianon.

Examples of preferred biocides of hydrophobic character as defined comprise fenpropimorph, chlorfenapyr, Picolinafen, or Dithianon.

Most preferred is a combination of Fenpropimorph and Dichlorprop. Another preferred combination comprises Fenpropimorph and Epoxiconazole, Fenpropimorph and Picolinafen.

The number of biocides in the composition selected from the group of active substances known as fungicides, insecticides, nematicides, acaricides, or herbicides may be selected by the skilled artisan according to the desired use of the microbicidal composition. However, in general the number should not exceed 10, preferably 5, and more preferably the number is from 2 to 4. Most preferably, it is a combination of two different biocides.

The proportion by weight of the biocides used may be selected by the skilled artisan according to the desired use of the microbicidal composition. For the case of two biocides the proportion in general .is from about 1:10-10:1, preferably 1:5-5:1, more preferably 1.2-2:1, and most preferably 1,5:1-1:1,5. For the case of more than two biocides it is preferred that each of the biocides used should be present in an amount of at least 10% related to the total amount of all biocides used.

The microbicidal composition comprising at least two different biocides according to the definition above is used for killing fungi, yeast, algae, and bacteria in industrial materials and/or industrial processes. Examples of such organisms comprise fungi such as Aspergillus niger and Chaetomium globosum, yeasts such as Saccharomyces cerevisiae, Candida albicans and Malassezia furfur, and certain organisms such as Pseudomonas fluorescens, Pseudomonas aeruginosa, Alcaligenes faecalis, Staphylococcus aureus, Staphylococcus epidermis, Corynebacterium xerosis, Propionibacterium acnes, Pityrosporum ovale, Aspergillus niger, Alternaria altemata, Aspergillus versicolor, Aureobasidium pullulans, Cladosporium cladosporioides, Penicillium purpurogenum, Penicillium funiculosum, Phoma violacea, Rhodotorula rubra, Sporobolomyces roseus, Stachybotrys chartarum, Ulocladium atrum, Chlorella sp, Pleurococcus sp, Nostoc muscorum, Oscillatoria tenuis, Stichococcus bacillaris, and Trentepohlia aurea.

The composition may be used as such, i.e. only a mixture of the active components is intensively mixed with or distributed in the industrial product. However, the active components can be formulated into e.g. pastes, emulsions or solutions or suspension or put onto solid carriers.

Preferably, a suitable microbicidal composition comprising the active compounds, a suitable solvent or solvent composition and optionally further components is used. In particular suitable are organic aliphatic solvents such as alcohols, i.e. ethanol, n-propanol or i-propanol, or aromatic solvents used in the preparation of plastics, coatings etc, such as phenoxyalcohols, or solvents and/or emulsifiers and other formulants known from agrochemical formulations. However it is also possible to formulate them as a suspension or dispersion using water or an aqueous solvent mixture and in addition suitable emulsifiers or other formulants, e.g. those known from agrochemical formulations.

As further components of the composition to be used there may be mentioned pH-adjusting additives, surfactants, emulsifiers, chelants, salts, corrosion inhibitors, dyes, fragrances, anti-foaming agents or dispersants, either alone or in combination.

The compositions can also contain optionally additional components which are effective as biocides.

In application, the active components as defined above are preferably used so as to provide a final concentration of from 0.001 to 10%, more preferably 0.01 to 5%, especially 0.02 to 0.5%, by weight of the liquid medium (including any liquid environment to be treated). In some anti-fouling coatings, preferred concentrations of active ingredient are preferably not below 0.5% and can be as high as 20%. In these formulations however, the most preferred level of active ingredient is above 1% and below 15%.

Concentrates may contain between 5 and 60%, more preferably between 10 and 45%, still more preferably between 20 to 40%, especially 20 to 30%, by weight of total concentrate, of the active components.

In particular, the pH of the microbicidal composition may vary from 2-12, as can that of the medium to be treated. It is preferred that the concentrate and more especially the treated product has a pH of at least 4, more preferably at least 7, still more preferably at least 8, especially 8 to 12.

For the use according to the present invention the industrial material is brought into contact with the microbicidal composition or the composition is used in the industrial process. The composition may be mixed with or distributed in the industrial product or the product treated with the composition. As a rule of thumb it can be stated that in general the degree of protection is the better the more homogeneous the distribution of the composition in the industrial product.

In a preferred embodiment of the invention, the microbicidal composition is used for in-can preservation of various compositions such as paints, lacquers, coatings compositions, technical fluids and the like. In a more preferred embodiment the composition is a coating composition comprising by the way of example calcium carbonate and/or titanium dioxide, binder, coalescent, solvent and water.

In a furthermore preferred embodiment of the invention, the microbicidal composition is used for the protection of coatings. Such coatings, preferably thin films, may be obtained by coating a suitable substrate such as wood and masonry with the coating composition comprising the microbicidal composition as described. The invention is not limited to a specific technique of coating. As suitable techniques for coating there may be mentioned exemplary spraying, painting, dipping, or printing.

The industrial material according to the second embodiment the invention comprising as biocide at least two different biocides as defined above usually contain the active components in a concentration of 0.05% to 2.5% by weight, preferably 0.1% to 1.0%, and most preferred 0.2% to 0.5%.

Dry films of the industrial materials have a high resistance against leaching out the biocides and are hence available for long-term protection. By the combination a broad spectrum activity is obtained that inhibits the growth of microorganisms not combatted by one particular biocide. The combination also offers protection due to the fact that upon drying, one component will migrate to the coated surface faster than the other and hence be available to kill or inhibit the most prevalent microorganisms in the environment, whilst the other compound will offer general protection as it too moves to the surface.

Embodiments of the invention will now be described in more detail with reference to the following examples.

Surface Coating

Testing was performed according to the BS3900 G6 and BBA MOAT 33 methods for evaluation versus fungi and algae, respectively. The methods involve painting a substrate panel with the coating and leaching under running water for 72 hours. The substrates are incubated for 56 days after being inoculated with fungi or algae. Performance is judged by comparing with suitable control samples ie without biocide, a positive control and for fungi with substrate panels that have not been leached.

Performance rating on painted test substrates (Score of 0, 1 and 2 is considered as a pass)
0=no growth
1=trace of growth
2=growth on 1-10% of test face
3=growth on 10-30% of test face
4=growth on 30-70% of test face

5=growth on 70-100% of test face.

TABLE 1
Efficacy Against Algal Growth On Painted Plaster Surface

| | MEAN ALGAL | | |
|---|---|---|---|
| | GROWTH RATING | | % Improved |
| TESTSYSTEM | 28 days | 56 days | after 56 days |
| Unpreserved Paint | 2 | 4 | — |
| 0.5% Chlorfenapyr | 3 | 3.5 | 12.5 |
| 0.5% Epoxiconazole | 2.5 | 2.5 | 37.5 |
| 0.5% Picolinafen | 1.5 | 2.5 | 37.5 |
| 0.5% Dithianon | 2 | 3.5 | 12.5 |
| 0.5% Fenpropimorph | 2 | 3 | 25.0 |

Epoxiconazole, Picolinafen, Fenpropimorph, Chlorfenapyr and Dithianon exhibited an improvement against algal growth on the plaster surface.

TABLE 2
Efficacy Against Fungal Growth On Painted Plaster Surface

| | MEAN FUNGAL GROWTH RATING - | | | | | |
|---|---|---|---|---|---|---|
| | PLASTER SUBSTRATE | | | | | |
| | | | | | % Improved | |
| | 28 days | | 56 days | | After 56 days | |
| TEST | as ap- | | as ap- | | as ap- | |
| SYSTEM | plied | leached | plied | leached | plied | leached |
| Unpreserved Paint | 4.5 | 3 | 5 | 3.5 | — | — |
| 0.5% Epoxiconazole | 3.5 | 1.5 | 3.5 | 2.5 | 30 | 29 |
| 0.5% Picolinafen | 4.5 | 3 | 5 | 3.5 | 0 | 0 |
| 0.5% Fenpropimorph | 4 | 3 | 4 | 3 | 20 | 14 |

As Applied - No leaching with water
Leached - Constant running water for 72 hours

Epoxiconazole and Fenpropimorph exhibited an improvement against fungal growth on the plaster surface either “as applied” or after leaching.

Chlorfenapyr, Dithianon and Picolinafen were similar to the unpreserved paint.

TABLE 3
Efficacy Against Fungal Growth On Painted Wooden Surface

| | MEAN FUNGAL GROWTH RATING - | | | | | |
|---|---|---|---|---|---|---|
| | WOOD SUBSTRATE | | | | | |
| | | | | | % Improved | |
| | 28 days | | 56 days | | After 56 days | |
| | as ap- | | as ap- | | as ap- | |
| TEST SYSTEM | plied | leached | plied | leached | plied | leached |
| Positive Control | 5 | n/a | 5 | n/a | — | — |
| Unpreserved Paint | 5 | 2 | 5 | 4 | — | — |
| 0.5% Chlorfenapyr | 5 | 3 | 5 | 3.5 | — | 12.5 |
| 0.5% Dithianon | 4 | 1.5 | 4 | 2 | 20 | 50 |

As Applied - No leaching with water
Leached - Constant running water for 72 hours

Chlorfenapyr and Dithianon exhibited an improvement against fungal growth on the wood surface. Epoxiconazole, Picolinafen and Fenpropimorph only showed marginal improvement.

Apart from the algal data, not all of the actives were effective. Combining the various attributes of the individual chemistries will provide additional benefits of broad range protection.

Combination of Actives

The chemistries were tested for their activity against a range of organisms via a microtitre plate method. The test organisms were:
ML—Micrococcus luteus
SA—Staphylococcus aureus
EC—Escherichia coli
PA—Pseudomonas aeruginosa
CF—Citrobacter freundii
PM—Proteus mirabilis
CA—Candida albicans
SC—Saccharomyces cerevisiae
AN—Aspergillus niger
PF—Penicillium funiculosum
AA—Alternaria alternata

Using the following rating scale:
0=no activity
1=minimal inhibition
2=inhibition
3=clear inhibition
4=clear inhibition biostatic, may be biocide activity
5=biostatic, may be biocide activity

Readings of 4 and possibly 3 were considered to be valid for biocidal applications.

Table 4 below shows that certain molecules give broad spectrum activity against bacteria and fungi when used in combination with each other.

TABLE 4
Intrinsic Activity Against Bacteria and Fungi

| | | Bacteria | | | | | | | Fungi | | | | | |
|---|---|---|---|---|---|---|---|---|---|---|---|---|---|---|
| | Conc. | | | | | | | Mean | | | | | | Mean |
| Sample | Ppm a.i. | ML | SA | EC | PA | CF | PM | Score | CA | SC | AN | PF | AA | Score |
| Dichlor- | 1000 | 5 | 5 | 5 | 5 | 5 | 5 | 5.0 | 5 | 5 | 5 | 5 | 5 | 5.0 |
| prop | 500 | 5 | 3 | 3 | 3 | 3 | 3 | 3.3 | 2 | 1 | 5 | 5 | 5 | 3.6 |
| Dodine | 1000 | 5 | 5 | 5 | 3 | 5 | 5 | 4.7 | 5 | 5 | 5 | 5 | 5 | 5.0 |
| | 500 | 5 | 5 | 5 | 1 | 5 | 5 | 4.3 | 5 | 5 | 5 | 5 | 5 | 5.0 |
| 2,4-D | 1000 | 5 | 3 | 3 | 3 | 5 | 2 | 3.5 | 5 | 3 | 5 | 5 | 5 | 4.6 |
| | 500 | 2 | 3 | 0 | 0 | 0 | 1 | 1.0 | 5 | 1 | 0 | 3 | 5 | 2.8 |
| Fenpro- | 1000 | 2 | 0 | 0 | 0 | 0 | 0 | 0.3 | 5 | 5 | 5 | 5 | 5 | 5.0 |
| pimorph | 500 | 0 | 0 | 0 | 0 | 0 | 0 | 0.0 | 5 | 5 | 5 | 5 | 5 | 5.0 |
| Epoxico- | 1000 | 0 | 0 | 0 | 0 | 0 | 0 | 0.0 | 5 | 5 | 5 | 3 | 5 | 4.6 |
| nazole | 500 | 0 | 0 | 0 | 0 | 0 | 0 | 0.0 | 5 | 5 | 5 | 3 | 5 | 4.6 |
| Dithianon | 1000 | 5 | 0 | 0 | 0 | 0 | 1 | 1.0 | 5 | 5 | 5 | 5 | 5 | 5.0 |
| | 500 | 3 | 3 | 0 | 0 | 0 | 1 | 1.2 | 5 | 5 | 5 | 5 | 5 | 5.0 |
| Metcona- | 1000 | 3 | 1 | 0 | 0 | 0 | 0 | 0.7 | 3 | 3 | 5 | 5 | 5 | 4.2 |
| zole | 500 | 2 | 1 | 0 | 0 | 0 | 0 | 0.5 | 3 | 3 | 5 | 5 | 5 | 4.2 |

Mean score = Performance against organisms/no of organisms
Rating score:
0 to <3 - Poor performance
>3 - Inhibition of organisms
>4 - Biostasis, Biocidal activity

Dichlorprop and Dodine show good activity against the test bacteria and fungi. Higher of 2,4-D and provide a similar effect.

Epoxiconazole Fenpropimorph, Dithianon and Metconazole only display antifungal activity at both concentrations.

Hence as an example, combining Dichlorprop at 500 ppm with Fenpropimorph also at 500 ppm provides broad spectrum microbial activity. Similarly other combinations can be put together using combinations of the above chemistries such as Fenpropimorph and Dodine. etc to provide broad spectrum performance versus microbes whilst utilizing the hydrophobic and limited solubility aspects of the two individual chemistries.

The following examples illustrate effective combinations of actives that provide a broad spectrum protection. The first figure indicates the required level of the active in the first column, the second figure indicates the level of required active in the first row of the table (values in ppm).

| | | | | Fenpropi- | Epoxi- | | | | |
|---|---|---|---|---|---|---|---|---|---|
| | Dichlorprop | Dodine | 2,4-D | morph | conazole | Dithianon | Metconazole | Picolinafen | Chlorfenapyr |
| Dichlorprop | — | | | 500 | | 500 | | | |
| | | | | 500 | | 500 | | | |
| Dodine | | — | | | | | | | |
| 2,4-D | | | — | 1000 | | | | | |
| | | | | 500 | | | | | |
| Fenpropimorph | 500 | 500 | 500 | — | | | | | |
| | 500 | 1000 | 500 | | | | | | |
| Epoxiconazole | 500 | 500 | 500 | 5000 | — | 5000 | | 5000 | 5000 |
| | 500 | 1000 | 500 | 5000 | | 5000 | | 5000 | 5000 |
| Dithianon | 500 | 500 | 500 | | | — | | | |
| | 500 | 1000 | 500 | | | | | | |
| Metconazole | 500 | 500 | 500 | | | | — | | |
| | 500 1000 | 500 | | | | | | | |
| Picolinafen | | | | | | | | — | |
| Chlorfenapyr | | | | 5000 | | 5000 | | | |
| | | | | 5000 | | 5000 | | | |

1-15. (canceled)

16. A microbicidal composition comprising at least two different biocides, wherein said biocides are selected from the group of active substances known as fungicides, insecticides, nematicides, acaricides, or herbicides in the field of crop protection each of said biocides comprising at least one structural element of the formula selected from the group of 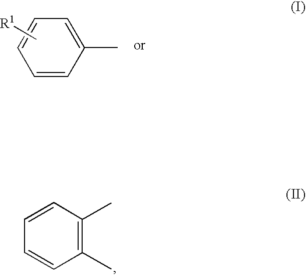
whereby R¹ is selected from the group consisting of F, Cl, and C₁—C₄-alkyl, and wherein at least one of the biocides used is of hydrophobic character having a solubility in water at room temperature not exceeding 500 ppm, and the other biocide(s) have a limited solubility in water at room temperature not exceeding 1000 ppm, and wherein the composition comprises at least one fungicide in combination with at least one compound selected from the group of insecticides, acaricides, nematicides, or herbicides.

17. The microbicidal composition according to claim 16, wherein the aromatic ring (I) comprises one or more additional substituents R² selected independently from the group consisting of F, Cl, C₁—C₄-alkyl, —O—CH₃ and —COOH.

18. The microbicidal composition according to claim 16, wherein the active substances are selected from the group consisting of 4-[2-Methyl-3-(p-tert.butylphenyl)-propyl]-2,6-cis-dimethylmorpholin, Fenpropimorph), 4-Brom-2-(p-chlorphenyl)-1-(ethoxymethyl)-5-(trifluormethyl)-pyrrole-3-carbonitril, Chlorfenapyr), 6-(3-Trifluormethyl-phenoxy)-pyridine-2-(N-4-fluorphenyl)-carboxylic acid amide (Picolinafen), 2,4-Dichlorophenoxypropionic acid (Dichlorprop), 2,4-Dichlorphenoxy acetic acid (2,4-D),2,3-Dicyano-1,4-dithia-anthraquinone (Dithianon), (1RS, 5RS; 1RS, 5SR)-5-(4-chlorobenzyl)-2,2-dimethyl-1-(1H-1,2,4-triazol-1-ylmethyl)cyclopentanol, Metconazole), and cis-3-(2-Chlorphenyl)-2-(4-fluorphenyl)-2-(triazol-1-ylmethyl)-oxiran (Epoxiconazole).

19. The microbicidal composition according to claim 16, wherein the composition comprises at least a mixture of 4-[2-Methyl-3-(p-tert.butylphenyl)-propyl]-2,6-cis-dimethylmorpholin (Fenpropimorph) and 2,4-Dichlorophenoxypropionic acid (Dichlorprop).

20. The microbicidal composition according to claim 16, wherein the composition comprises at least a mixture of 4-[2-Methyl-3-(p-tert.butylphenyl)-propyl]-2,6-cis-dimethylmorpholin (Fenpropimorph) and 6-(3-Trifluormethyl-phenoxy)-pyridine-2-(N-4-fluorphenyl)-carboxylic acid amide (Picolinafen).

21. The microbicidal composition according to claim 16, wherein the mixture is used for in-can preservation of compositions.

22. The microbicidal composition according to claim 21, wherein the composition is a coating composition.

23. The microbicidal composition according to claim 16, wherein the mixture is used for the protection of coatings.

24. Industrial material comprising at least two different biocides for protection, wherein said biocides are selected from the group of active substances known as fungicides, insecticides, acaricides, nematicides or herbicides in the field of crop protection each of said biocides comprising at least one structural element selected from the group of 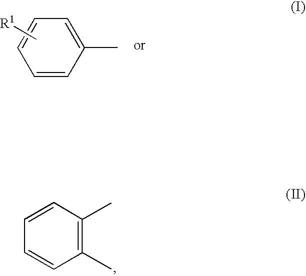
whereby R¹ is selected from the group of F, Cl, and C₁—C₄-alkyl, and wherein at least one of the biocides used is of hydrophobic character having a solubility not exceeding 500 ppm, and the other biocide(s) used have a limited solubility in water at room temperature not exceeding 1000 ppm, and wherein the composition comprises at least one fungicide in combination with at least one compound selected from the group of insecticides, acaricides, nematicides, or herbicides.

25. Industrial material according to claim 24, wherein the aromatic ring (I) comprises one or more additional substituents R² selected independently from the group consisting of F, Cl, C₁—C₄-alkyl, —O—CH₃ and —COOH.

26. Industrial material according to claim 24, wherein the active substances are selected from the group consisting of 4-[2-Methyl-3-(p-tert.butylphenyl)-propyl]-2,6-cis-dimethylmorpholin (Fenpropimorph), 4-Brom-2-(p-chlorphenyl)-1-(ethoxymethyl)-5-(trifluormethyl)-pyrrole-3-carbonitril (Chlorfenapyr), 6-(3-Trifluormethyl-phenoxy)-pyridine-2-(N-4-fluorphenyl)-carboxylic acid amide (Picolinafen), 2,4-Dichlorophenoxypropionic acid (Dichlorprop), 2,4-Dichlorphenoxy acetic acid (2,4-D), 2,3-Dicyano-1,4-dithia-anthraquinone (Dithianon), (1RS, 5RS; 1RS, 5SR)-5-(4-chlorobenzyl)-2,2-dimethyl-1-(1H-1,2,4-triazol-1-ylmethyl)cyclopentanol (Metconazole), and cis-3-(2-Chlorphenyl)-2-(4-fluorphenyl)-2-(triazol-1-ylmethyl)-oxiran (Epoxiconazole).

27. Industrial material according to claim 24, wherein the composition comprises at least a mixture of 4-[2-Methyl-3-(p-tert.butylphenyl)-propyl]-2,6-cis-dimethylmorpholin (Fenpropimorph) and 2,4-Dichlorophenoxypropionic acid (Dichlorprop).

28. Industrial material according to claim 24, wherein the composition comprises at least a mixture of 4-[2-Methyl-3-(p-tert.butylphenyl)-propyl]-2,6-cis-dimethylmorpholin (Fenpropimorph) and 6-(3-Trifluormethyl-phenoxy)-pyridine-2-(N-4-fluorphenyl)-carboxylic acid amide (Picolinafen).

29. Industrial material according to claim 24, wherein the industrial material is a coating composition.

30. Industrial material according to claim 24, wherein the industrial material is a dry film obtained using a coating composition.
